(19) United States
(12) Patent Application Publication
(10) Pub. No.: US 2007/0022044 A1
(43) Pub. Date: Jan. 25, 2007

(54) Information processor, optimization processing method, collateral allocation method, and recording medium

(75) Inventor: Hiroki Takeshita, Tokyo (JP)

Correspondence Address: ARENT FOX PLLC, 1050 CONNECTICUT AVENUE, N.W., SUITE 400, WASHINGTON, DC, 20036, US

(73) Assignee: NS SOLUTIONS CORPORATION

(21) Appl. No.: 11/480,938

(22) Filed: Jul. 6, 2006

(30) Foreign Application Priority Data
Jul. 22, 2005 (JP) 2005-212886
Nov. 2, 2005 (JP) 2005-319940

(51) Int. Cl. G06Q 40/00

(52) U.S. Cl. 705/38

(57) ABSTRACT

An information processor includes: a priority acquisition means; a collateral/loan information acquisition means; and an optimization processing means executing processing related to optimization when reducing a risk amount of loan by collateral allocation, by linear programming using priorities acquired by the priority acquisition means and collateral information and loan information acquired by the collateral/loan information acquisition means.

### CROSS-REFERENCE TO RELATED APPLICATIONS

This application is based upon and claims the benefit of priority from the prior Japanese Patent Application Nos. 2005-212886, filed on Jul. 22, 2005, and 2005-319940, filed on Nov. 2, 2005, the entire contents of which are incorporated herein by reference.

### BACKGROUND OF THE INVENTION

1. Field of the Invention

The present invention relates to an information processor, an optimization processing method, a collateral allocation method, and a recording medium.

2. Description of the Related Art

Conventionally, banks and so on have needed to assess the risk amount (or risk) of loan when executing loan (financing) operation. This risk amount is used for finding an index representing the soundness of management of the bank itself.

For example, one index representing the soundness of management of the bank itself is the capital adequacy ratio of the bank. The value of the capital adequacy ratio increases as the risk amount is reduced. As restriction related to the capital adequacy ratio, Basel II is a known. In Basel II, the method or the like of allocating financial asset collateral, real estate collateral or the like taken as collateral for the loan to reduce the risk amount has a certain degree of freedom.

(Patent Document 1)

Japanese Patent Application Laid-open No. 2001-184334

However, the loan and the collateral have a complex relationship with each other, causing a problem of difficulty in performing allocate optimization when reducing the risk amount of loan by collateral allocation. Further, the bank may have previously determined the order of collateral allocation according to priority (for example, the financial asset collateral being at a higher priority than the real estate collateral or the like), and has a problem of difficulty in performing optimization in consideration of such priority.

Another problem is that it is difficult to provide an allocate processing technique when reducing the risk amount of loan by collateral allocation because a method out of a practical business of financial institution cannot be performed or because the loan and the collateral have a complex relationship with each other though the reduction of the risk amount can be set freely to some extent.

### SUMMARY OF THE INVENTION

The present invention has been developed in consideration of the above-described problems, and an object of the invention is to provide a technique relating to optimization when reducing the risk amount of loan by collateral allocation in consideration of the priority of collateral allocation previously determined by a bank or the like. Further, the present invention has been developed in consideration of the above-described problems, and another object of the present invention is to provide an allocate processing technique when reducing the risk amount of loan by collateral allocation.

Hence, to solve the above-described problems, an information processor of the present invention includes a priority acquisition means acquiring priorities from a priority storage means storing priorities related to collateral allocation; a collateral/loan information acquisition means acquiring collateral information and loan information about a credit customer being a processing object from a collateral/loan information storage means storing collateral information related to securities and loan information related to loans in a corresponding manner for each credit customer; and an optimization processing means executing processing related to optimization when reducing a risk amount of loan by collateral allocation, by linear programming using the priorities acquired by the priority acquisition means and the collateral information and the loan information acquired by the collateral/loan information acquisition means.

According to the information processor of the present invention, the processor includes a priority acquisition means acquiring priorities from a priority storage means storing priorities related to collateral allocation; a collateral/loan information acquisition means acquiring collateral information and loan information about a credit customer being a processing object from a collateral/loan information storage means storing collateral information related to securities and loan information related to loans in a corresponding manner for each credit customer; and an optimization processing means executing processing related to optimization when reducing a risk amount of loan by collateral allocation, by linear programming using the priorities acquired by the priority acquisition means and the collateral information and the loan information acquired by the collateral/loan information acquisition means, whereby a technique can be provided which relates to optimization when reducing the risk amount of loan by collateral allocation in consideration of the priority of the collateral allocation which has been previously determined by a bank or the like

Note that the information processor corresponds, for example, to a later-described information processor 1 or the like. Further, the priority storage means corresponds, for example, to a later-described priority storage unit 26 or the like. Further, the priority acquisition means corresponds, for example, to a later-described priority acquisition unit 23 or the like. Further, the collateral/loan information storage means corresponds, for example, to a collateral/loan information storage unit 27 or the like. Further, the collateral/loan information acquisition means corresponds, for example, to a later-described collateral/loan information acquisition unit 24 or the like. Further, the optimization processing means corresponds, for example, to a later-described optimization processing unit 25 or the like.

Further, an information processor of the present invention includes a collateral/loan information acquisition means acquiring collateral information and loan information about a credit customer being a processing object from a collateral/loan information storage means storing collateral information related to securities and loan information related to loans in a corresponding manner for each credit customer; an objective function calculation means calculating an objective function related to linear programming with an amount of the collateral allocated for the loan as a variable, based on the collateral information and the loan information; a first replacing means replacing at least one or more variables of the variables of the objective functions with a sum of a first variable representing an amount of the collateral evenly allocated for the loans and a second variable representing, if there is a remaining amount of the collateral, an amount of the remaining amount individually allocated for the loans, and weighting the first variable; and a replacing means replacing the variables related to the constraint conditions of the objective functions with a sum of a first variable representing an amount of the collateral evenly allocated for the loans and a second variable representing, if there is a remaining amount of the collateral, an amount of the remaining amount individually allocated for the loans.

According to the information processor of the present invention, the processor includes a collateral/loan information acquisition means acquiring collateral information and loan information about a credit customer being a processing object from a collateral/loan information storage means storing collateral information related to securities and loan information related to loans in a corresponding manner for each credit customer; an objective function calculation means calculating an objective function related to linear programming with an amount of the collateral allocated for the loan as a variable, based on the collateral information and the loan information; a first replacing means replacing at least one or more variables of the variable of the objective function with a sum of a first variable representing an amount of the collateral evenly allocated for the loans and a second variable representing, if there is a remaining amount of the collateral, an amount of the remaining amount individually allocated for the loans, and weighting the first variable; and a replacing means replacing the variables related to the constraint conditions of the objective functions with a sum of a first variable representing an amount of the collateral evenly allocated for the loans and a second variable representing, if there is a remaining amount of the collateral, an amount of the remaining amount individually allocated for the loans, in which the variable of the objective function is divided into a portion to be evenly allocated for the loans and a portion individually allocated for the loans and then the portion of the collateral to be evenly allocated for the loans is weighted, whereby an allocate processing technique when reducing a risk amount of loan by collateral allocation can be provided which evenly allocates a collateral for a plurality of loans or the like and thereafter individually allocates a remaining amount of the collateral, if preset, the remaining amount of the collateral for the loans.

Note that the information processor corresponds, for example, to a later-described information processor 1 or the like. Further, the collateral/loan information storage means corresponds, for example, to a collateral/loan information storage unit 310 or the like. Further, the collateral/loan information acquisition means corresponds, for example, to a later-described collateral/loan information acquisition unit 210 or the like. Further, the objective function calculation means corresponds, for example, to a later-described objective function calculation unit 220 or the like. Further, the first replacing means corresponds, for example, to a first replacing unit 240 or the like.

Further, to solve the above-described problems, the present invention may be an optimization processing method, a collateral allocation method, and a recording medium.

### BRIEF DESCRIPTION OF THE DRAWINGS

FIG. 1 is a hardware configuration diagram of one example of an information processor;

FIG. 2 is a functional configuration diagram of one example of the information processor;

FIG. 3A is a view (part 1) showing an example of a priority rule selection screen;

FIG. 3B is a view (part 2) showing an example of the priority rule selection screen;

FIG. 3C is a view (part 3) showing an example of the priority rule selection screen;

FIG. 4 is a table showing examples of collateral information and loan information;

FIG. 5A is a graph (part 1) graphically representing Expression 1;

FIG. 5B is a graph (part 2) graphically representing Expression 1;

FIG. 6A is a conceptual graph for explaining the concept when an optimal solution is found by general linear programming;

FIG. 6B is a conceptual graph for explaining the basic concept related to embodiments of the present invention;

FIG. 7A is a graph (part 1) for explaining a method of increasing the coefficient of a variable x1 at a higher priority;

FIG. 7B is a graph (part 2) for explaining the method of increasing the coefficient of the variable x1 at a higher priority;

FIG. 8 is a diagram showing an example of a functional configuration of an optimization processing unit;

FIG. 9 is a graph illustrating an objective function and so on when the amount of EXP is large with respect to CRM in the case in which the priority is set for each CRM;

FIG. 10 is a graph illustrating the objective function and so on when the amount of EXP is small with respect to CRM in the case in which the priority is set for each CRM;

FIG. 11 is a graph illustrating the objective functions and so on related to CRMs at the same priority in the case in which the priority is set for each CRM;

FIG. 12 is a graph illustrating different objective functions and so on in the case in which the priority is set for each EXP;

FIG. 13 is a conceptual diagram related to the present invention;

FIG. 14 is a graph showing an example of a certain collateral allocated for loans in a second embodiment;

FIG. 15 is a graph showing an example of a certain collateral allocated for loans in a third embodiment;

FIG. 16 is a graph showing an example of a plurality of securities allocated for loans in the third embodiment;

FIG. 17 is a graph showing a problem in the third embodiment;

FIG. 18 is a functional configuration diagram of one example of an information processor in a fifth embodiment;

FIG. 19 is a graph showing an example of a plurality of securities allocated for loans in the fifth embodiment; and

FIG. 20 is a functional configuration diagram of one example of an information processor in a sixth embodiment.

### DETAILED DESCRIPTION OF THE PREFERRED EMBODIMENTS

Hereinafter, embodiments of the present invention will be described based on the drawings.

(First Embodiment)

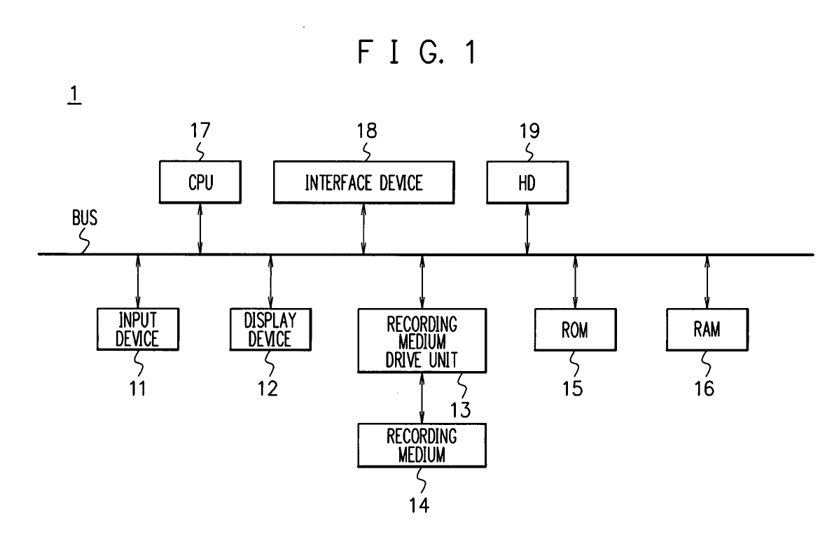

FIG. 1 is a hardware configuration diagram of one example of an information processor. As shown in FIG. 1, the information processor 1 includes, as a hardware configuration, an input device 11, a display device 12, a recording medium drive unit 13, a ROM (Read Only Memory) 15, a RAM (Random Access Memory) 16, a CPU (Central Processing Unit) 17, an interface device 18, and an HD (Hard Disk) 19.

The input device 11 is composed of a keyboard, a mouse and the like operated by an operator (or a user) of the information processor 1, and is used for inputting various kinds of operation information and so on into the information processor 1. The display device 12 is composed of a display or the like used by the user of the information processor 1 and used for displaying various kinds of information (or screens). The interface device 18 is an interface which connects the information processor 1 to networks and so on.

An optimization processing program is provided to the information processor 1 by a recording medium 14, for example, a CD-ROM or the like or downloaded over the networks or the like. The recording medium 14 is set in the recording medium drive unit 13, so that the optimization processing program is installed into the HD 19 from the recording medium 14 via the recording medium drive unit 13.

The ROM 15 stores programs and so on which are initially read into the information processor 1 at the time of power-on of the information processor 1. The RAM 16 is a main memory of the information processor 1. The CPU 17 reads out, when necessary, the optimization processing program from the HD 19, stores the program into the RAM 16, and executes the optimization processing program to thereby provide part of later-described functions and execute later-described flowcharts and so on. In addition to the optimization processing program, the HD 19 further stores, for example, later-described priorities (priority information), collateral information, loan information, and so on. Note that all or some information of the priorities, the collateral information, the loan information and so on may be stored in the HD or the like of another apparatus connected to the information processor 1 over the network. It should be noted that the description will be provided assuming that the priorities, the collateral information, the loan information and so on are stored in the HD 19 for simplification of explanation.

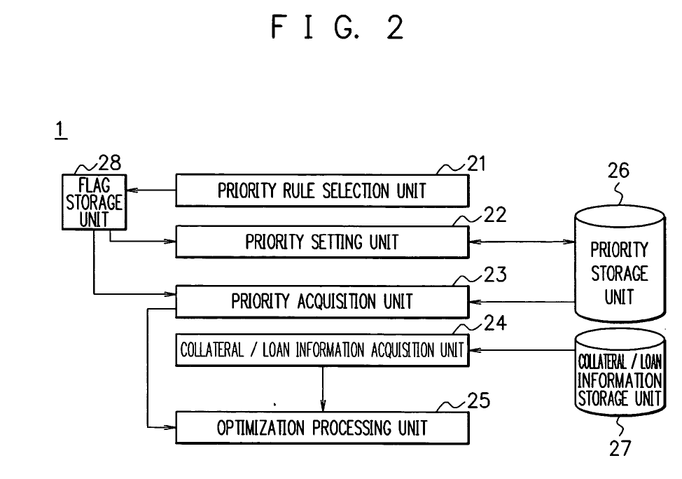

An example of a functional configuration of the information processor 1 which is composed of the CPU 17, the RAM 16, the HD 19, an analysis data display program and so on is illustrated below in FIG. 2. FIG. 2 is a functional configuration diagram of an example of the information processor. As shown in FIG. 2, the information processor 1 includes a priority rule selection unit 21, a priority setting unit 22, a priority acquisition unit 23, a collateral/loan information acquisition unit 24, an optimization processing unit 25, a priority storage unit 26, a collateral/loan information storage unit 27, and a flag storage unit 28.

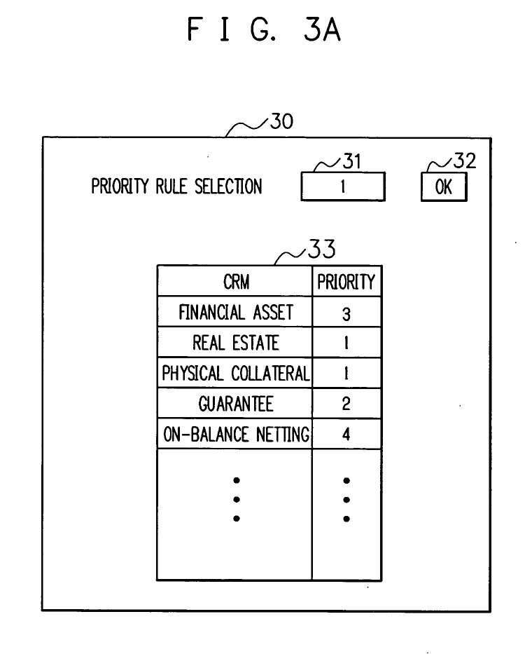

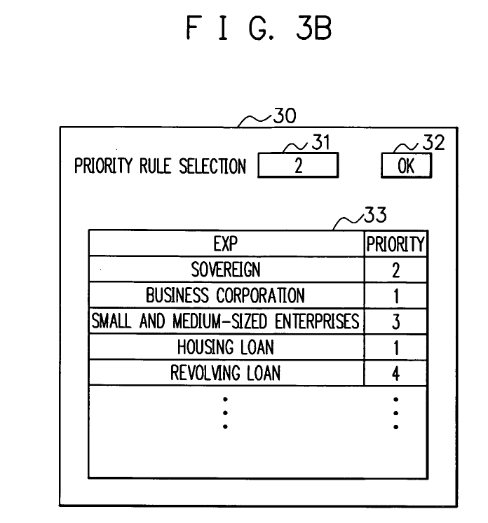

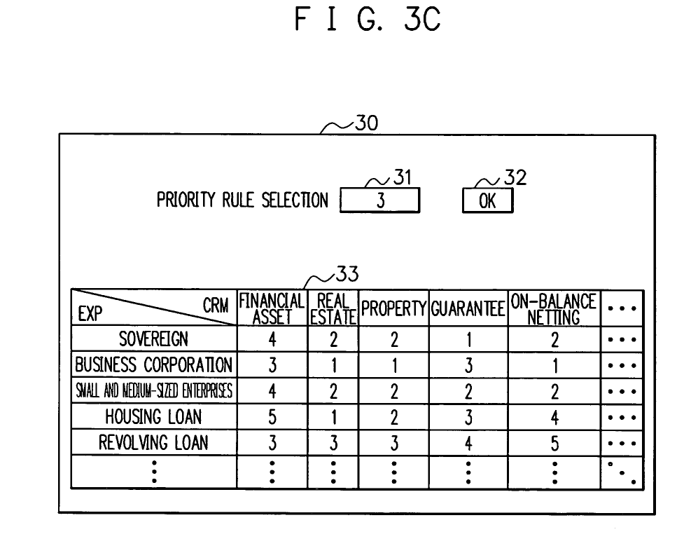

The priority rule selection unit 21 selects a priority rule in response to a demand from the user or the like, and sets a value (one of later-described numerical values 0 to 3) identifying the selected priority rule, for example, into a priority rule selection flag stored in the flag storage unit 28 or the like. Examples of a priority rule selection screen 30 are shown here in FIG. 3A to FIG. 3C. FIG. 3A is a view (part 1) showing an example of the priority rule selection screen. FIG. 3B is a view (part 2) showing an example of the priority rule selection screen. FIG. 3C is a view (part 3) showing an example of the priority rule selection screen. As described later, an example of the priority rule selection screen 30 where “CRM (credit risk mitigation): collateral” is selected as the priority rule is shown in FIG. 3A. Further, an example of the priority rule selection screen 30 where “EXP (exposure): loan” is selected as the priority rule is shown in FIG. 3B. Further, an example of the priority rule selection screen 30 where “combination of CRM and EXP” is selected as the priority rule is shown in FIG. 3C.

The user inputs (selects), for example, one numerical value from among 0 to 3 into a numerical value input (selection) region 31 of the priority rule selection screen 30, and presses an OK button 32 to thereby select and decide the priority rule. A numerical value 0 here represents selecting no priority rule (that is, no execution of linear programming using the priorities), a numerical value 1 represents selecting “CRM” as the priority rule, a numerical value 2 represents selecting “EXP” as the priority rule, and a numerical value 3 represents selecting “combination of CRM and EXP” as the priority rule. The priority rule selection unit 21 receives, from the priority rule selection screen 30 or the like, information related to the priority rule which the user has selected using the priority rule selection screen 30 (that is, the numerical value which the user has inputted (selected)), and sets the received numerical value in the priority rule selection flag stored in the flag storage unit 28 or the like.

Returning to the explanation of FIG. 2 again, when the value is set in the priority rule selection flag stored in the flag storage unit 28 or the like, the priority setting unit 22 acquires the information related to the priorities set for each priority rule from the priority storage unit 26 according to the value set in the priority rule selection flag (that is the priority rule), and displays the information within a priority setting (change) region 33 of the priority rule selection screen 30 as shown in FIGS. 3A to 3C. The information related to the priorities refers to, for example, where the priority rule is “CRM,” CRMs (for example, financial asset, real estate and so on) and priorities for the CRMs as shown in FIG. 3A; where the priority rule is “EXP,” EXPs (for example, sovereign, business corporation and so on) and priorities for the EXPs as shown in FIG. 3B; or where the priority rule is “combination of CRM and EXP,” combinations of CRMs and EXPs and priorities for the combinations of CRMs and EXPs as shown in FIG. 3C.

According to the value (that is, the priority rule) set in the priority rule selection flag stored in the flag storage unit 28 or the like, the priority acquisition unit 23 acquires corresponding priorities from the priority storage unit 26.

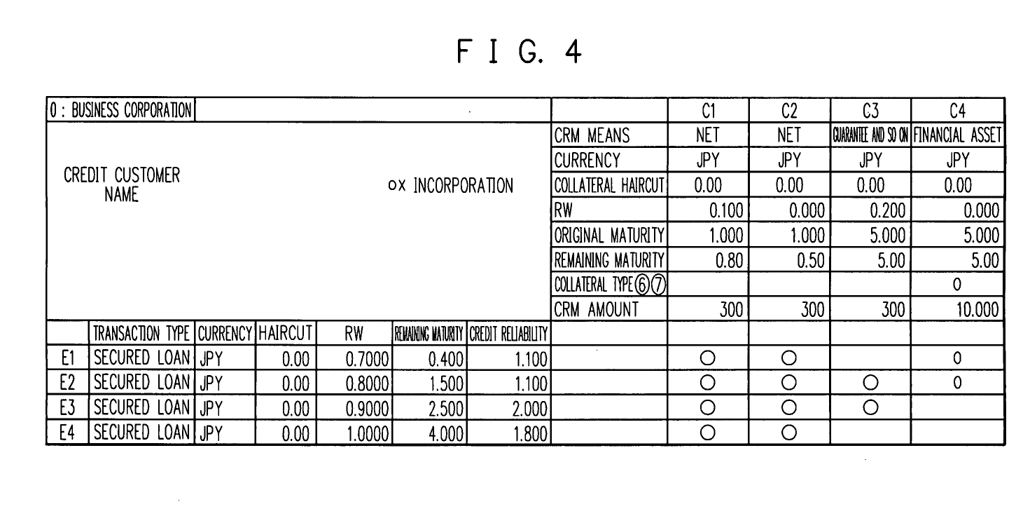

The collateral/loan information acquisition unit 24 acquires collateral information and loan information about a credit customer being a processing object from the collateral/loan information storage unit 27. The collateral/loan information storage unit 27 stores the collateral information related to securities and loan information related to loans in a corresponding manner for each credit customer. Examples of the collateral information and the loan information stored in the collateral/loan information storage unit 27 are shown in FIG. 4. FIG. 4 is a table showing examples of the collateral information and the loan information. E1 to E4 in FIG. 4 are abbreviations of EXPs, that is, loans (loan information), respectively, and C1 to C4 are abbreviations of CRMs, that is, securities (collateral information), respectively. As shown in FIG. 4, the collateral information and the loan information are associated with each other.

Returning to the explanation of FIG. 2 again, the optimization processing unit 25 executes processing of optimization when reducing the risk amount of loan (maximization of the amount of reduction) by collateral allocation by the linear programming using the priorities acquired by the priority acquisition unit 23 and the collateral information and the loan information acquired by the collateral/loan information acquisition unit 24. The optimization processing unit 25 maximizes an objective function.
Reduction amount=Σij (CRMij·reduction coefficient ij) (Expression 1)
Here constraint conditions are as follows.
RWAi=uncovered i+Σj (CRMij·reduction coefficient ij)
CRMj=unallocated j+Σi (CRMij)
EXP*i=uncovered *i+Σj (CRMij·adjustment coefficient ij)
Here,

the reduction coefficient ij is a risk amount reduced by CRMij and is zero when any collateral cannot be allocated.

The adjustment coefficient ij is a coefficient for use in converting CRMij into the amount after adjustment, and is zero when any collateral cannot be allocated.

RWAi is RWA of an i-th EXP. Here, RWA is a risk asset which is obtained by multiplying the risk weight (a coefficient when calculating a risk index) of a transaction by the amount of EXP of that transaction.

CRMj is the amount of a j-th CRM.

EXP*i is the amount after adjustment of the i-th EXP.

These reduction coefficient ij, adjustment coefficient ij, RWAi, CRMj, and EXP*i which are constants are included, for example, in the collateral information and/or the loan information and stored in the collateral/loan information storage unit 27 or the like so that the collateral/loan information acquisition unit 24 acquires and provides them to the optimization processing unit 25.

Besides,

the reduction amount is a total of RWA reduced by all the CRMij.

CRMij is the amount of the j-th CRM allocated for the i-th EXP.

The uncovered i is RWA of a portion of the i-th EXP uncovered by CRM.

The uncovered j is the amount of a portion of the j-th CRM unallocated for EXP.

The uncovered *i is the amount after adjustment of the portion of the i-th EXP uncovered by CRM.

The optimization processing unit 25 executes optimization processing by the linear programming using the above-described reduction coefficient ij, adjustment coefficient ij, RWAi, CRMj, EXP*i and so on which are constants, so as to find the reduction amount, CRMij, uncovered i, unallocated j, uncovered *i and so on which are variables.

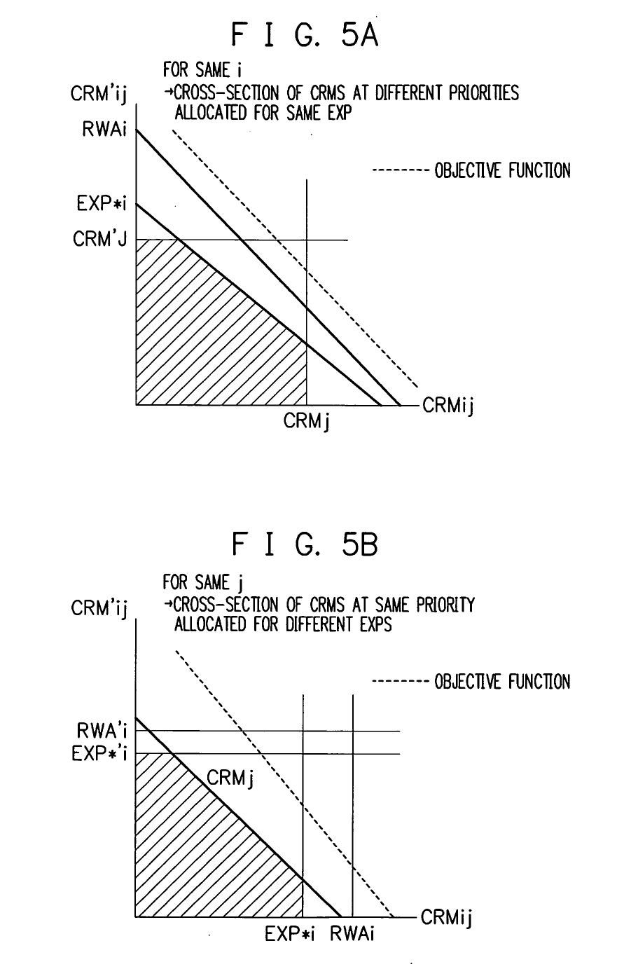

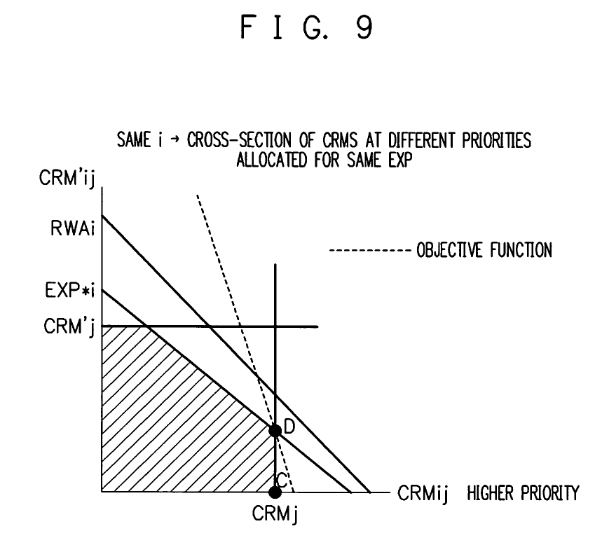

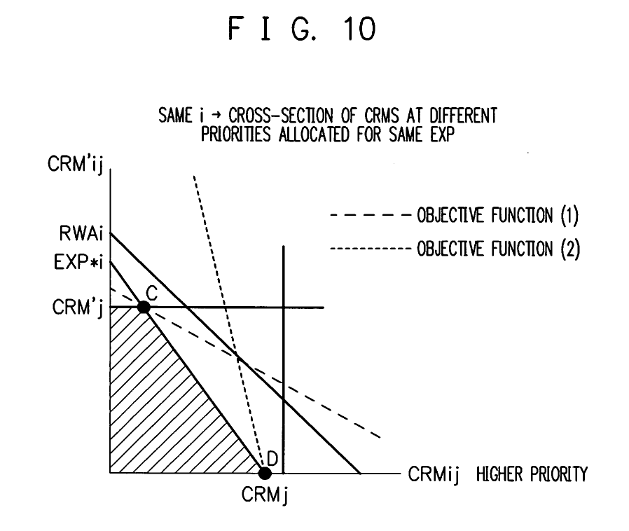

Here, illustration of the above Expression 1 is shown in FIGS. 5A and 5B. FIG. 5A is a graph (part 1) graphically representing Expression 1. FIG. 5B is a graph (part 2) graphically representing Expression 1. Note that the positional relationship between straight lines varies depending on the magnitudes of the constants and not-shown variables. Further, although the graph expressed by Expression 1 and the constraint conditions is actually multidimensional, only a certain cross-section of the graph expressed in multiple dimensions is shown in FIGS. 5A and 5B for easy understanding. This also applies to later-described FIG. 9 through FIG. 12.

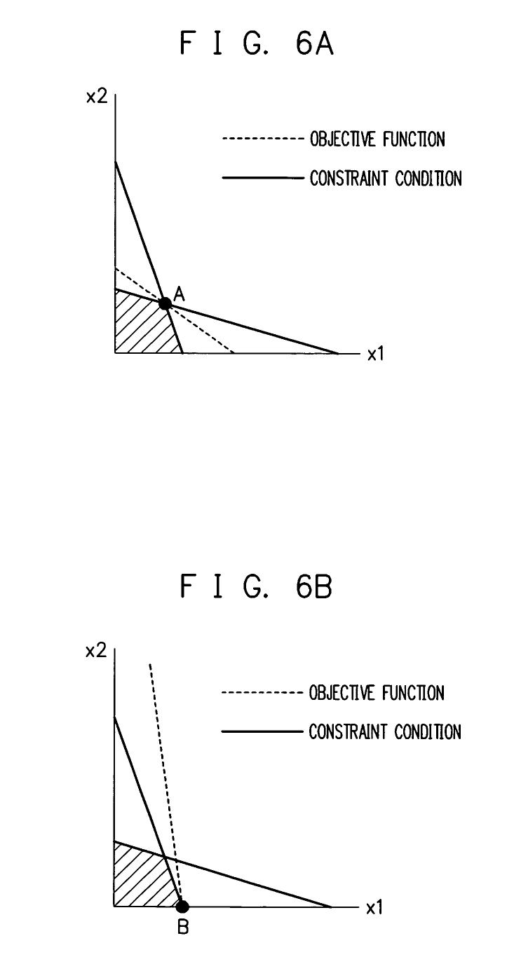

Next, a basic concept related to the embodiments of the present invention will be described using FIGS. 6A and 6B. FIG. 6A is a conceptual graph for explaining the concept when an optimal solution is found by general linear programming. Besides, FIG. 6B is a conceptual graph for explaining the basic concept related to the embodiments of the present invention.

In FIG. 6A, two thick lines are lines obtained from the mathematical expression representing the constraint conditions in the linear programming, and two lines obtained from two constraint conditional expressions are shown in the case shown in FIG. 6A. Finding a point at which the objective function is maximum (the objective function is minimum depending on the purpose) under such constraint conditions is the linear programming. In FIG. 6A, the line obtained from the objective function is shown by a dotted line, and the dotted line is translated with respect to an x1-axis or an x2-axis to find out a maximum point in the general linear programming. In the case of FIG. 6A, the objective function is maximum under the conditions at the point A as is clear from the graph.

On the other hand, in the present invention, the maximum value is found by varying the slope of the dotted line representing the objective function without sticking to finding the maximum value by translating the objective function. When the coefficient of the variable x1 of the objective function is increased under the circumstances with the constraint conditions and the objective function as shown in FIG. 6A, the slope of the objective function changes, for example, as shown in FIG. 6B. Due to a change in slope of the objective function, the contact point between the constraint condition and the objective function moves, as shown in FIGS. 6A and 6B, from the point A to the point B (the value of x1 is larger at the point B). Since increasing the coefficient of the variable x1 means that the value of x1 should be increased naturally (even if other variables are decreased) for maximizing the objective function, the above-described result of movement of the contact point between the constraint condition and the objective function from the point A to the point B is logical. Note that the variable x1 is at a higher priority than the variable x2.

As a method of increasing the coefficient of a variable xi at a higher priority, the two methods shown below are conceivable here. Note that i is a natural number of 1 or greater (similarly in the following).
(ai+b)xi (1)
(ai·b)xi (2)

ai is a coefficient of xi.

Besides, b is a sufficiently large number relative to ai.

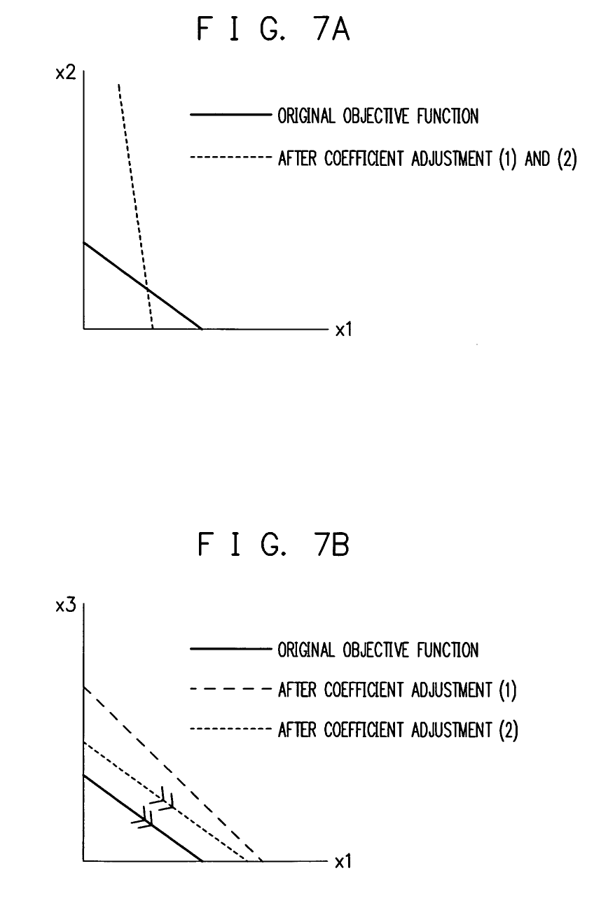

Assuming that x1 of x1 and x2 is a variable at a higher priority, the slopes of the objective functions of above-described both cases (1) and (2) are substantially the same as shown in FIG. 7A. FIG. 7A is a graph (part 1) for explaining the method of increasing the coefficient of the variable x1 at a higher priority.

On the other hand, assuming that x1 and x3 are variables at the same priority, the slopes of the objective functions of above-described both cases (1) and (2) are different as shown in FIG. 7B. FIG. 7B is a graph (part 2) for explaining the method of increasing the coefficient of the variable x1 at a high priority. Assuming that x1 and x3 are variables at the same priority as shown in FIG. 7B, the slope of the objective function is substantially the same as the slope of the original objective function in the above-described case (2), while the slope of the objective function is almost −1 in the above-described case (1). This is because b is a number sufficiently large relative to a1 and a3. Since the slope of the objective function is quite important in the linear programming as shown in FIGS. 5A and 5B and FIGS. 6A and 6B, the method of (2) is employed in the embodiment of the present invention.

Accordingly, the coefficient ai is replaced with ai·bk for {∀xi; xi ∈Gk} of the variable xi forming objective function
z=Σi (ai·xi) (Expression 2)
Note that the constraint conditions are not changed.

Gk represents a group at a certain priority, in which the priority in greater (higher) as k is greater, and bk has the following relationship.
b1<<b2<< . . . <<bn

Here Expression 2 is made by generalizing Expression 1 for simplification of explanation.

The optimization processing unit 25 makes the objective function as expressed by Expression 2 the objective function
z=Σi (ai·bk·xi) (Expression 3)

bk=mˆk

and maximizes the objective function expressed by Expression 3.

Here, m is a multiplier, for example, a number sufficiently large relative to ai, such as 10, 100, 1000, or the like.

Besides, k is a priority and stored in the priority storage unit 26 for each CRM, and/or for each EXP, and/or for each combination of CRM and EXP as described above. Note that there may be a plurality of CRM (CRM kinds) or EXP (EXP categories) at the same priority.

Note that if no priority is set, the optimization processing unit 25 maximizes the objective function expressed by Expression 3 with m=0 and k=0. More specifically, assuming that m=0 and k=0, mˆk=0ˆ0=1, and therefore Expression 3 equals to Expression 2, so that the objective function becomes equal to the original objective function.

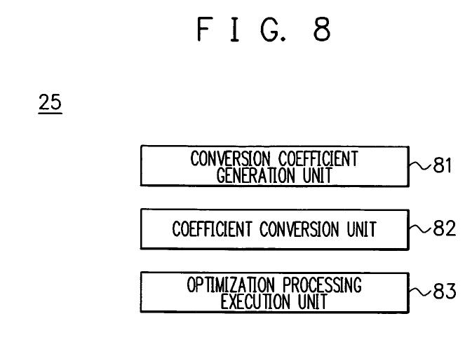

An example of the functional configuration of the optimization processing unit 25 is shown in FIG. 8. FIG. 8 is a diagram showing an example of a functional configuration of the optimization processing unit. As shown in FIG. 8, the optimization processing unit 25 includes, as the functional configuration, a conversion coefficient generation unit 81, a coefficient conversion unit 82, and an optimization processing execution unit 83.

The conversion coefficient generation unit 81 generates a conversion coefficient (the above-described bk) using the priorities acquired by the priority acquisition unit 23 (or the priorities, and the collateral information and/or the loan information acquired by the collateral/loan information acquisition unit 24).

The coefficient conversion unit 82 converts the coefficient of the variable of the objective function using the conversion coefficient generated by the conversion coefficient generation unit 81. In other words, the coefficient conversion unit 82 converts the coefficient ai of the variable xi of the objective function as described above to ai·bk using the conversion coefficient bk.

The optimization processing execution unit 83 finds the solution of the objective function as expressed by the above-described Expression 3 using the coefficient converted by the coefficient conversion unit 82 (that is, ai·bk).

Hereinafter, the concept of processing and so on of finding the solution of the objective function in the optimization processing unit 25 will be described taking, as an example, the case in which the priority is set for each CRM (or “CRM” is selected as the priority rule) using FIG. 9 to FIG. 11. FIG. 9 is a graph illustrating the objective function and so on when the amount of EXP is large with respect to CRM in the case in which the priority is set for each CRM. Note that CRMij is a CRM at a higher priority than CRM′ij as shown in FIG. 9.

As a result of the coefficient conversion by the coefficient conversion unit 82 and so on, the slope of the objective function is as shown in FIG. 9. FIG. 9 shows an example in which aij is converted to aij·b and a′ij is converted to a′ij for simplification of explanation. In other words, FIG. 9 shows an example in which only the coefficient aij of the variable CRMij is converted, and even when aij is converted to aij·bk+1 and a′ij is converted to a′ij·bk, the slope of the objective function is the same as shown in FIG. 9. Note that there is a relation that b=bk +1/bk.

A point D shown in FIG. 9 (the solution found by optimization processing) is a point where the amount of CRM′ij becomes larger with the amount of CRMij being the same as that at the point C. More specifically, a variable at a lower priority (the amount of CRM′ij) does not always become zero but is allocated in the case as shown in FIG. 9.

FIG. 10 is a graph illustrating the objective function and so on when the amount of EXP is small with respect to CRM in the case in which the priority is set for each CRM. Note that CRMij is a CRM at a higher priority than CRM′ij as shown in FIG. 10.

The objective function (1) shown in FIG. 10 represents the original objective function, and the objective function (2) shown in FIG. 10 represents the objective function after the optimization processing unit 25 or the like has performed coefficient conversion according to priority for the objective function (1) (aij→aij·b and a′ij→a′ij). Any point on a straight line EXP*i is in a state fully covering EXP*i, and the objective function (2) shown in FIG. 10 intersects with the straight line EXP*i at the point D. This means that the objective function (2) allocates only the CRMij and does not fully cover EXP*i.

On the other hand, the objective function (1) (the objective function before the coefficient conversion according to priority) intersects with the straight line EXP*i at the point C. This is not the state in which the objective function (1) preferentially allocates the CRMij than CRM′ij.

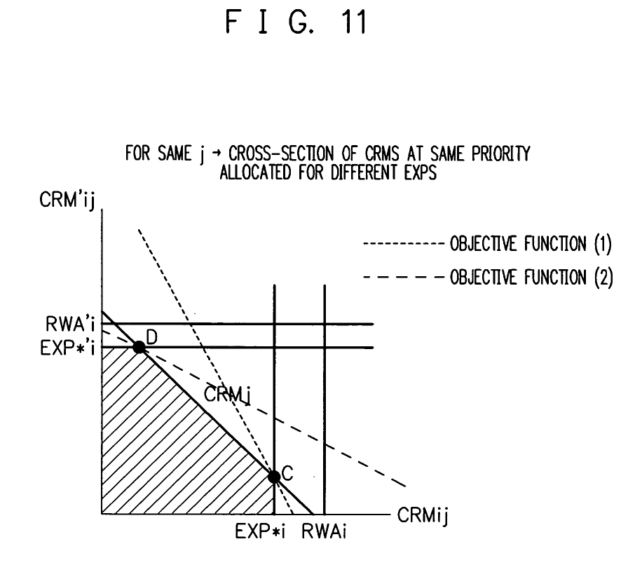

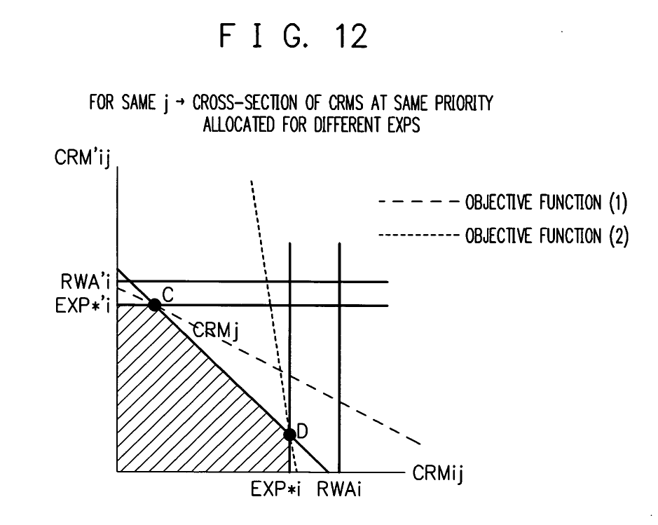

FIG. 11 is a graph illustrating the objective functions and so on related to CRMs at the same priority in the case in which the priority is set for each CRM. Note that the case in FIG. 11 shows two objective functions with different slopes (the objective function (1) and the objective function (2)) about the cross-section of the same variable at different priorities.

In the case of the slope as shown by the objective function (1) (that is, when the coefficient CRMij is larger than the coefficient of CRM′ij), the objective function (1) intersects with the constraint condition at the point C. On the other hand, in the case of the slope as shown by the objective function (2) (that is, when the coefficient CRMij is smaller than the coefficient of CRM′ij), the objective function (2) intersects with the constraint condition at the point D.

Points on a straight line represent the state in which all the CRMj is allocated. More specifically, FIG. 11 represents that a larger portion of CRM with a larger coefficient is allocated. The slopes of the objective function (1) and the objective function (2) shown in FIG. 11 are not affected by the coefficient conversion according to priority performed by the optimization processing unit 25 or the like. This is because the variable CRMij and the variable CRM′ij are at the same priority. Accordingly, the point where the objective function (1) shown in FIG. 11 intersects with the constraint condition (the point C) and the point where the objective function (2) shown in FIG. 11 intersects with the constraint condition (the point D) are not different from those before the coefficient conversion according to priority, so that the relationship between the variables is maintained if they at the same priority.

Hereinafter, the processing and so on of finding the solution of the objective function in the optimization processing unit 25 will be described taking, as an example, the case in which the priority is set for each EXP (or “EXP” is selected as the priority rule) using FIG. 12. FIG. 12 is a graph illustrating different objective functions and so on in the case in which the priority is set for each EXP.

FIG. 12 shows the objective function (1) as the original objective function, and the objective function (2) as the objective function after the optimization processing unit 25 or the like has performed coefficient conversion according to priority for the objective function (1) (aij→aij·b and a′ij→a′ij).

The point C where the objective function (1) intersects with the constraint condition indicates that a larger portion of a certain CRMj is allocated for EXP*′i. On the other hand, the point D where the objective function (2) after the coefficient conversion according to priority performed by the optimization processing unit 25 or the like intersects with the constraint condition indicates that CRMj is preferentially allocated for EXP*i.

As for the cross-section of variables with the same i, that is, the cross-section of the variables at the same priority (different CRMs allocated for the same EXP), the slopes of the objective functions are not affected by the coefficient conversion according to priority so that the slopes of the objective functions before the coefficient conversion according to priority and after the coefficient conversion according to priority are maintained, similarly to those shown in FIG. 11, and therefore the points where the objective functions intersect with the constraint conditions are the same.

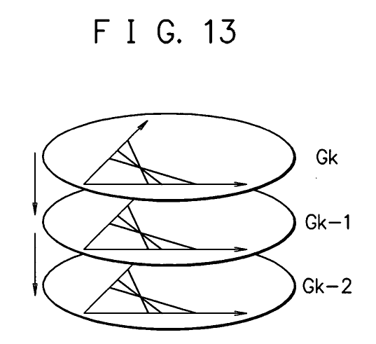

Hereinafter, the concept related to the present invention is shown in FIG. 13. FIG. 13 is a conceptual diagram related to the present invention. The effects of the coefficient conversion according to priority have been seen in two-dimensional cross-sections in the above-described graphs, and the effects are combined into those shown in FIG. 13. In a space defined by variables at the same priority included in a group Gk, the slope of the objective function is not changed by the coefficient conversion, so that the optimization processing unit 25 or the like performs optimization by the linear programming irrespective of the priority. Variables included in a group Gk-1 at a lower priority than the group Gk can be changed in value within a range in which the variables in the group Gk are (hardly or) not decreased, so that the optimization processing unit 25 or the like performs optimization within the range. This also applies to a group Gk-2 and following groups at much lower priorities. Note that the definition of the priority groups can be set in the information processor 1, for example, ex post facto according to the needs of banks and the like independently of the contents (problems) of the linear programming.

As described above, according to this embodiment, for example, the linear programming is used basically, while the coefficient change of the objective function, which is not performed in the conventional linear programming, is performed at the time of performing optimization when reducing the risk amount of loan by collateral allocation, whereby a technique can be provided which enables optimization of collateral allocation (minimization of the risk amount) in consideration of the priority of the collateral allocation which has been previously determined by a bank or the like. Further, as described above, according to this embodiment, the bank or the like can set (change) the priority at any time, thus performing more flexible optimization in accordance with the purpose of the bank or the like.

Although the amount of reduction is the total of RWA reduced by all the CRMij in the above-described embodiment, the RWA may be replaced with UL+12.5·EL. Note that UL refers to Unexpected Loss, and EL refers to Expected Loss. Further, 12.5 means ⅛%.

(Second Embodiment)

The hardware configuration of an information processor 1 in the following embodiment is the same as the hardware configuration of the information processor 1 shown in FIG. 1 of the first embodiment.

Note that the collateral allocation program is provided to the information processor 1 by a recording medium 14 such as a CD-ROM or the like, or downloaded over a network or the like. The recording medium 14 is set in a recording medium drive unit 13, so that the collateral allocation program is installed in an HD 19 via the recording medium drive unit 13 from the recording medium 14.

A CPU 17 reads out, when necessary, the collateral allocation program from the HD 19, stores the program into a RAM 16, and executes the collateral allocation program to thereby provide part or all of later-described functions and execute a later-described flowchart and so on. In addition to the collateral allocation program, the HD 19 stores, for example, later-described collateral information, loan information and so on. Note that all or some of the collateral information, the loan information and so on may be stored in the HD or the like of another apparatus connected to the information processor 1 over the network. However, the description will be provided assuming that the collateral information, the loan information and so on are stored in the HD 19 for simplification of explanation.

The information processor 1 (the CPU 17 or the collateral allocation program or the like) of the second embodiment performs collateral allocation processing of maximizing the objective function of (Expression 1) shown below under constraint conditions shown below (Constraint conditions 1, 2 and 3) based on the collateral information and the loan information. Note that CRM (credit risk mitigation) means collateral (collateral information). Besides, EXP (exposure) means loan (loan information).
Reduction amount=Σij (CRM ij·reduction coefficient ij) (Expression 4)
RWAi=uncovered i+Σj (CRM ij·reduction coefficient ij) (Constraint condition 1)
CRMj=unallocated j+Σi (CRM ij) (Constraint condition 2)
EXP*i=uncovered *i+Σj (CRM ij·adjustment coefficient ij) (Constraint condition 3)
Here,

the reduction coefficient ij is a risk amount reduced by CRMij and is zero when any collateral cannot be allocated.

The adjustment coefficient ij is a coefficient for use in converting CRMij into the amount after adjustment, and is zero when any collateral cannot be allocated.

RWAi is RWA of the i-th EXP. Here, RWA is a risk asset which is obtained by multiplying the risk weight (a coefficient when calculating a risk index) of a transaction by the amount of EXP of that transaction.

CRMj is the amount of a j-th CRM.

EXP*i is the amount after adjustment of the i-th EXP.

These reduction coefficient ij, adjustment coefficient ij, RWAi, CRMj, and EXP*i which are constants are included, for example, in the collateral information and/or the loan information and stored in the HD 19 so that the information processor 1 acquires and uses the constants.

Besides, the reduction amount is a total of RWA reduced by all the CRMij.

CRMij is the amount of the j-th CRM allocated for the i-th EXP.

The uncovered i is RWA of a portion of the i-th EXP uncovered by CRM.

The uncovered j is the amount of a portion of the j-th CRM unallocated for EXP.

The uncovered *i is the amount after adjustment of the portion of the i-th EXP uncovered by CRM.

The information processor 1 executes optimization processing by the linear programming using the above-described reduction coefficient ij, adjustment coefficient ij, RWAi, CRMj, EXP*i and so on which are constants, so as to find the reduction amount, CRMij, uncovered i, the unallocated j, uncovered *i and so on which are variables.

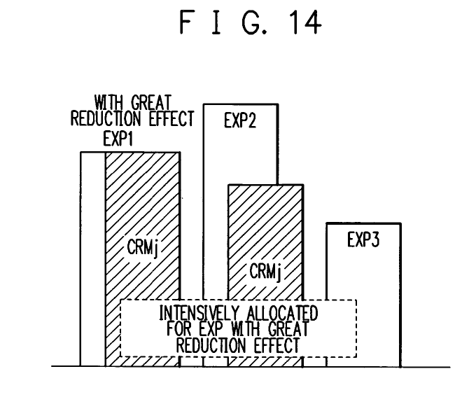

FIG. 14 is a graph showing an example of a certain collateral allocated for loans in the second embodiment. As shown in FIG. 14, in the case of the method (processing) of the second embodiment, the collateral is intensively allocated for the EXP with the maximum reduction effect (EXP1 in the case of FIG. 14).

Accordingly, in the method (processing) shown in the second embodiment, for example, the reduction amount is greatest as compared with later-described other embodiments. However, it is impossible to evenly allocate the collateral, for example, for a plurality of loans by the method (processing) shown in the second embodiment.

(Third Embodiment) In the third embodiment, a method (processing) of evenly allocating a collateral, for example, for a plurality of loans will be described. Note that the variable CRMij shown in the second embodiment is expressed as xij, and the reduction coefficient ij is omitted for simplification of explanation in the, following embodiment.

The information processor 1 of the third embodiment replaces the variable xij of the objective function such that
xij→cij*pj (Replacement 1)
and executes processing of maximizing the reduction amount. Note that cij is a constant and pj is a variable.

More specifically, as shown in FIG. 14 of the second embodiment, when CRMj covers EXP1, EXP2, and EXP3, x1j, x2j, and x3j are handled as three independent variables in the second embodiment, but x1j, x2j, and x3j are replaced with one variable pj as follows in this embodiment. This is because three variables changing in proportion means. that they are substantially one variable rather than three independent variables.
x1j→c1j*pj
x2j→c2j*pj
x3j→c3j*pj

Here, assuming that cij is defined such that
cij=(the amount of EXPi)/((1−H)*M),
the ratio of CRMs after respective adjustment of x1j, x2j, and x3j becomes the same as the ratio of the amounts of EXP1, EXP2, and EXP3.

Here,

H is a haircut (a loan-to-value ratio to adjust the risk such as price change of the collateral and so on).

M is a maturity adjustment (in the case of the maturity of CRM being shorter than the maturity of EXP, a loan-to-value ratio to adjust the shortage (a numerical value of 1 or smaller)).

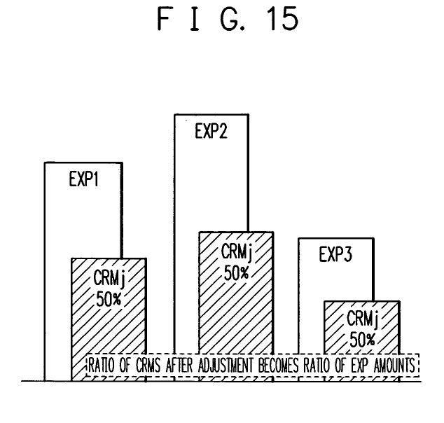

FIG. 15 is a graph showing an example of a certain collateral allocated for loans in the third embodiment. As shown in FIG. 15, in the case of the method (processing) of the third embodiment, the collateral is evenly allocated for the loans.

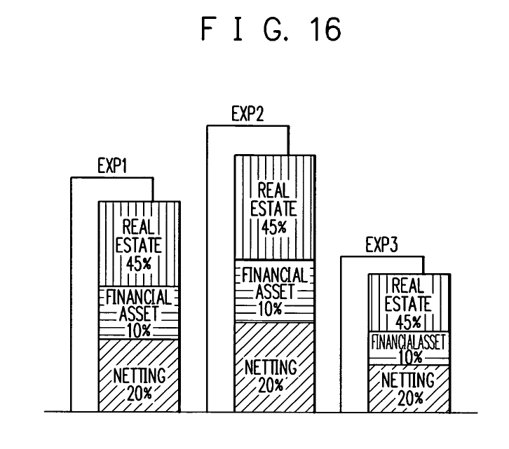

FIG. 16 is a graph showing an example of a plurality of securities allocated for loans in the third embodiment. As shown in FIG. 16, in the case of the method (processing) of the third embodiment, the securities are evenly allocated for the loans (EXP1, ECXP2, and EXP3) in the order of on-balance netting (hereinafter, referred to as netting), financial asset, and real estate.

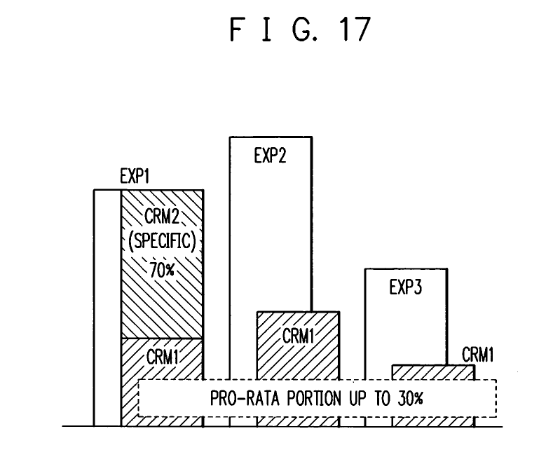

Accordingly, in the method (processing) illustrated in the third embodiment, the securities can be evenly allocated for the loans. However, as shown in FIG. 17, CRM2 (specific collateral) is at a higher priority than CRM1, so that when 70% of EXP1 is covered first by CRM2, the upper limit of CRM1 capable of being evenly allocated for EXP1, EXP2, and EXP3 is 30%, causing a problem of impossibility of CRM 1 being allocated for them even if there is a remaining amount of CRM1.

(Fourth Embodiment)

In the fourth embodiment, a method (processing) of individually allocating a remaining amount of a certain collateral, if present, for loans will be described.

An information processor 1 of the fourth embodiment replaces the variable xij of the objective function such that
xij→cij*pj+qij (Replacement 2)
and executes processing of maximizing the reduction amount. Note that cij is a constant, pj is a variable, and qij is a variable.

Here, pj represents a portion of the collateral to be allocated for the loans in proportion (pro-rata) (by the method illustrated in the third embodiment) (hereinafter referred to as a pro-rata portion), and qij represents a portion of the collateral to be individually (by the method illustrated in the second embodiment) allocated for the loans (hereinafter, referred to as an individual portion).

However, the information processor 1 replaces the variable xij by the above-described (Replacement 2), substitutes the result into the objective function of the above-described (Expression 4), and performs collateral allocation processing for maximization under the above-described (Constraint condition 1), (Constraint condition 2), and (Constraint condition 3), resulting in pj=0. In short, the allocation of the pro-rata portion is not performed. This is because assuming that, for example, the reduction amount by allocation of CRM is large in EXP1 among EXP1, EXP2, and EXP3, and the reduction amount by allocation of CRM is small in EXP3, the reduction amount of the pro-rata portion is a weighted average of the reduction amount by allocation of CRM related to EXP1 and the reduction amount by allocation of CRM related to EXP3. Accordingly, the reduction amount by allocation of the pro-rata portion is smaller than the reduction amount by allocation of the individual portion to EXP1 and larger than the reduction amount by allocation of the individual portion to EXP3.

(Fifth Embodiment)

In the fifth embodiment, the method (processing) of individually allocating a remaining amount of a certain collateral, if present, for loans will be described continuously.

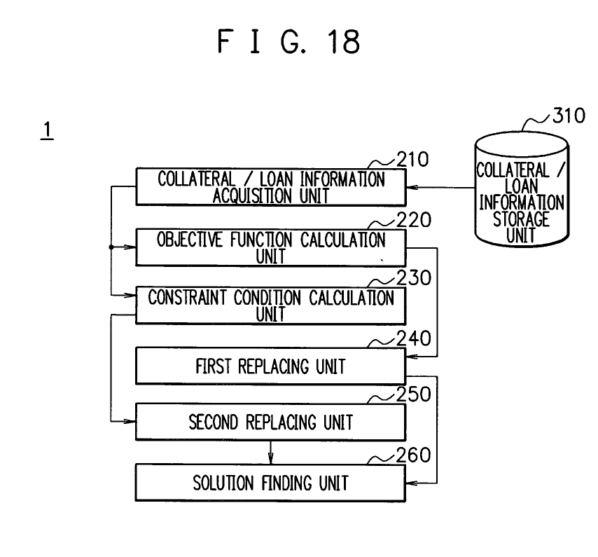

Hereinafter, one example of a functional configuration of an information processor 1 in the fifth embodiment is shown in FIG. 18, which comprises a CPU 17, a RAM 16, an HD 19, a collateral allocation program, and so on. As shown in FIG. 18, the information processor 1, as a functional configuration, a collateral/loan information acquisition unit 210, an objective function calculation unit 220, a constraint condition calculation unit 230, a first replacing unit 240, a second replacing unit 250, a solution finding unit 260, and a collateral/loan information storage unit 310.

The collateral/loan information acquisition unit 210 acquires collateral information and loan information about a credit customer being a processing object from the collateral/loan information storage unit 310. The collateral/loan information storage unit 310 stores the collateral information related to securities and the loan information related to loans in a corresponding manner for each credit customer (see FIG. 4 of the first embodiment).

The objective function calculation unit 220 calculates the objective function of the above-described (Expression 4) using the collateral information and the loan information acquired by the collateral/loan information acquisition unit 210. The constraint condition calculation unit 230 calculates the constraint conditions of the above-described (Constraint condition 1), (Constraint condition 2), and (Constraint condition 3) using the collateral information and the loan information acquired by the collateral/loan information acquisition unit 210.

The first replacing unit 240 replaces (replaces and weights) the variable xij of the objective function calculated by the objective function calculation unit 220 such that
xij→b*cij*pj+qij (Replacement 3).
Note that cij is a constant and pj is a variable. Besides b is a value sufficiently large with respect to qij, such as 10, 100, 1000, or the like.

The second replacing unit 250 replaces the variable xij of the constraint conditions calculated by the constraint condition calculation unit 230 such that
xij→cij*pj+qij (Replacement 4).

The solution finding unit 260 finds a solution using linear programming by substituting the variable xij replaced by the first replacing unit 240 into the objective function calculated by the objective function calculation unit 220 and substituting the variable xij replaced by the second replacing unit 250 into the constraint condition calculated by the constraint condition calculation unit 230. Further, the solution finding unit 260 calculates the value of the original variable xij from the found solution.

In the case of the fifth embodiment, since b, which is a sufficiently large value with respect to qij, is weighted to the pro-rata portion as shown in (Replacement 3), allocation of the pro-rata portion is preferentially performed to allocation of the individual portion. This is because it is more advantageous that the pro-rata portion with a large coefficient (allocation of the pro-rata portion) is made as large as possible in the linear programming for maximization of the objective function.

In other words, when the variable xij of the objective function is replaced as shown in (Replacement 3), in conjunction with which the variable xij of the constraint condition is replaced as shown in (Replacement 4), and the objective function is then maximized under the constraint condition using the linear programming, a solution is found with which allocation of the individual portion is performed when there is a remaining amount of collateral after the allocation of the pro-rata portion.

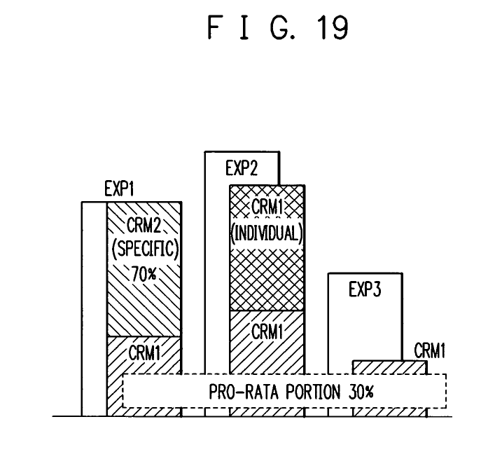

FIG. 19 is a graph showing an example of a plurality of securities allocated for loans in the fifth embodiment. As shown in FIG. 19, in the case of the method (processing) of the fifth embodiment, CRM2 (specific collateral) is at a higher priority than CRM1, and even if 70% of EXP1 is covered first by CRM2, when there is a remaining amount of CRM 1 after CRM is evenly allocated EXP1, EXP2, and EXP3, the remaining amount of CRM 1 is individually allocated (for EXP2 in the case of FIG. 19).

According to the method (processing) illustrated in the fifth embodiment, an allocate processing technique when reducing the risk amount of loan by collateral allocation can be provided, which evenly allocates a certain collateral for a plurality of loans or the like.

(Sixth Embodiment)

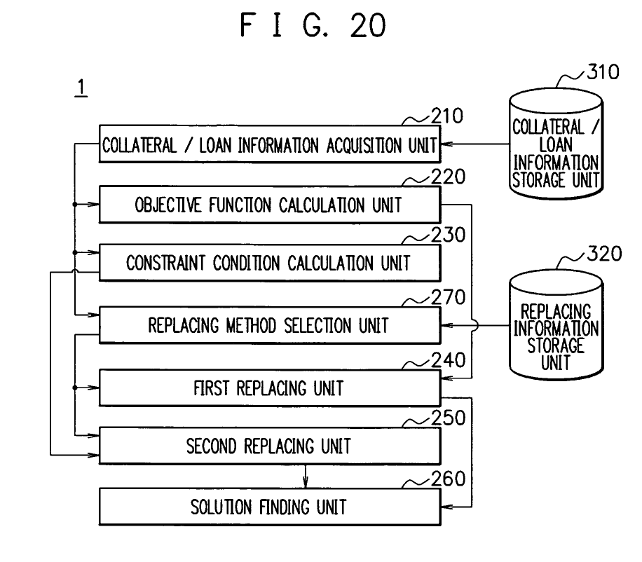

In the sixth embodiment, a method (processing) of performing the above-described embodiments in combination will be described. Hereinafter, one example of a functional configuration of an information processor 1 in the sixth embodiment is shown in FIG. 20, which comprises a CPU 17, a RAM 16, an HD 19, a collateral allocation program and so on. FIG. 20 is a functional configuration diagram of one example of the information processor in the sixth embodiment. As shown in FIG. 20, the information processor 1, as a functional configuration, a collateral/loan information acquisition unit 210, an objective function calculation unit 220, a constraint condition calculation unit 230, a first replacing unit 240, a second replacing unit 250, a solution finding unit 260, a replacing method selection unit 270, a collateral/loan information storage unit 310, and a replacing information storage unit 320.

The collateral/loan information acquisition unit 210 acquires collateral information and loan information about a credit customer being a processing object from the collateral/loan information storage unit 310. The collateral/loan information storage unit 310 stores the collateral information related to securities and the loan information related to loans in a corresponding manner for each credit customer.

The objective function calculation unit 220 calculates the objective function of the above-described (Expression 4) using the collateral information, the loan information and so on acquired by the collateral/loan information acquisition unit 210. The constraint condition calculation unit 230 calculates the constraint conditions of the above-described (Constraint condition 1), (Constraint condition 2), and (Constraint condition 3) using the collateral information, the loan information, and so on acquired by the collateral/loan information acquisition unit 210.

The replacing method selection unit 270 selects and acquires a method of replacing a variable depending on the kind of CRM (collateral) from the replacing information storage unit 320. The replacing information storage unit 320 stores, as replacing information, the kind of CRM (the CRM kind information) and the replacing method of a variable (the replacing method information) in a corresponding manner.

Examples of the replacing information include, for example,

CRM is real estate: No replacement

CRM is on-balance: (Replacement 1)

CRM is revolving guarantee: (Replacement 3)+(Replacement 4)

and so on. Here, No replacement corresponds to the method or the like of the above-described second embodiment, (Replacement 1) corresponds to the method or the like of the above-described third embodiment, and (Replacement 3)+(Replacement 4) corresponds to the method or the like of the above-described fifth embodiment.

The first replacing unit 240 replaces (or does not replace) the variable xij of the objective function calculated by the objective function calculation unit 220 according to the replacing method selected by the replacing method selection unit 270. The second replacing unit 250 replaces (or does not replace) the variable xij of the constraint condition calculated by the constraint condition calculation unit+according to the replacing method selected by the replacing method selection unit 270.

The solution finding unit 260 finds a solution using linear programming for maximization of the objective function under the constraint condition based on the output result of the first replacing unit 240 and the output result of the second replacing unit 250. Further, the solution finding unit 260 calculates the value of the original variable xij from the found solution.

According to the method (processing) illustrated in the sixth embodiment, the allocation method for loan can be changed depending on the kind of collateral.

Although preferred embodiments of the present invention have been described above, the present invention is not limited to the particular embodiments, but various changes and modifications may be made within the scope of the present invention as set forth in claims.

According to the present invention, a technique can be provided which relates to optimization when reducing the risk amount of loan by collateral allocation in consideration of the priority of the collateral allocation which has been previously determined by a bank or the like.

Further, according to the present invention, an allocate processing technique when reducing the risk amount of loan by collateral allocation can be provided.

What is claimed is:

1. An information processor, comprising:
a priority acquisition means acquiring priorities from a priority storage means storing priorities related to collateral allocation;
a collateral/loan information acquisition means acquiring collateral information and loan information about a credit customer being a processing object from a collateral/loan information storage means storing collateral information related to securities and loan information related to loans in a corresponding manner for each credit customer; and
an optimization processing means executing processing related to optimization when reducing a risk amount of loan by collateral allocation, by linear programming using the priorities acquired by said priority acquisition means and the collateral information and the loan information acquired by said collateral/loan information acquisition means.

2. The information processor according to claim 1,
wherein said optimization processing means comprises:
a conversion coefficient generation means generating a conversion coefficient using the priorities acquired by said priority acquisition means;
a coefficient conversion means converting a coefficient of a variable of an objective function in the linear programming with an amount of the collateral allocated for the loan as the variable, using the conversion coefficient generated by said conversion coefficient generation means; and
an optimization processing execution means finding a solution of the objective function using the coefficient converted by said coefficient conversion means.

3. The information processor according to claim 1,
wherein the priorities are stored in said priority storage means according to a plurality of priority rules;
wherein said processor further comprises a priority rule selection means selecting a priority rule, and
wherein said priority acquisition means acquires from said priority storage means priorities according to the priority rule selected by said priority rule selection means.

4. The information processor according to claim 3,
wherein one of the priority rules is the collateral information, and
wherein the priorities are stored in said priority storage means according to the collateral information.

5. The information processor according to claim 3,
wherein one of the priority rules is the loan information, and
wherein the priorities are stored in said priority storage means according to the loan information.

6. The information processor according to claim 3,
wherein one of the priority rules is a combination of the collateral information and the collateral information, and
wherein the priorities are stored in said priority storage means according to the combination of the collateral information and the collateral information.

7. The information processor according to claim 1, further comprising:
said priority storage means.

8. The information processor according to claim 1, further comprising:
said collateral/loan information storage means.

9. An information processor, comprising:
a collateral/loan information acquisition means acquiring collateral information and loan information about a credit customer being a processing object from a collateral/loan information storage means storing collateral information related to securities and loan information related to loans in a corresponding manner for each credit customer;
an objective function calculation means calculating an objective function related to linear programming with an amount of the collateral allocated for the loan as a variable, based on the collateral information and the loan information; and
a first replacing means replacing at least one or more variables of the variables of the objective functions with a sum of a first variable representing an amount of the collateral evenly allocated for the loans and a second variable representing, if there is a remaining amount of the collateral, an amount of the remaining amount individually allocated for the loans, and weighting the first variable.

10. The information processor according to claim 9, further comprising:
a constraint condition calculation means calculating a constraint condition related to the linear programming with the amount of the collateral allocated for the loan as a variable, based on the collateral information and the loan information.

11. The information processor according to claim 10, further comprising:
a second replacing means replacing variable(s) related to the variable(s) replaced by said first replacing means of the variables of the constraint conditions with a sum of a first variable representing an amount of the collateral evenly allocated for the loans and a second variable representing, if there is a remaining amount of the collateral, an amount of the remaining amount individually allocated for the loans.

12. The information processor according to claim 11, further comprising:
a solution finding means finding a solution using the linear programming based on the objective function replaced and weighted by said first replacing means and the constraint condition replaced by said second replacing means.

13. The information processor according to claim 9, further comprising:
a replacing method selection means selecting a replacing method of a variable depending on the kind of the collateral.

14. The information processor according to claim 13, further comprising:
a replacing information storage means storing information on the kind of the collateral and the variable replacing method,
wherein said replacing method selection means identifies the information stored in said replacing information storage means depending on the kind of the collateral and selects the variable replacing method.

15. An optimization processing method in an information processor, comprising the steps of:
a priority acquisition step of acquiring priorities from a priority storage means storing priorities related to collateral allocation;
a collateral/loan information acquisition step of acquiring collateral information and loan information about a credit customer being a processing object from a collateral/loan information storage means storing collateral information related to securities and loan information related to loans in a corresponding manner for each credit customer; and
an optimization processing step of executing processing related to optimization when reducing a risk amount of loan by collateral allocation, by linear programming using the priorities acquired in said priority acquisition step and the collateral information and the loan information acquired in said collateral/loan information acquisition step.

16. A collateral allocation method in an information processor, comprising the steps of:
a collateral/loan information acquisition step of acquiring collateral information and loan information about a credit customer being a processing object from a collateral/loan information storage means storing collateral information related to securities and loan information related to loans in a corresponding manner for each credit customer;
an objective function calculation step of calculating an objective function related to linear programming with an amount of the collateral allocated for the loan as a variable, based on the collateral information and the loan information; and
a first replacing step of replacing at least one or more variables of the variables of the objective functions with a sum of a first variable representing an amount of the collateral evenly allocated for the loans and a second variable representing, if there is a remaining amount of the collateral, an amount of the remaining amount individually allocated for the loans, and weighting the first variable.

17. A computer-readable recording medium recording an optimization processing program to cause a computer to function as:
a priority acquisition means acquiring priorities from a priority storage means storing priorities related to collateral allocation;
a collateral/loan information acquisition means acquiring collateral information and loan information about a credit customer being a processing object from a collateral/loan information storage means storing collateral information related to securities and loan information related to loans in a corresponding manner for each credit customer; and
an optimization processing means executing processing related to optimization when reducing a risk amount of loan by collateral allocation, by linear programming using the priorities acquired by said priority acquisition means and the collateral information and the loan information acquired by said collateral/loan information acquisition means.

18. A computer-readable recording medium recording a collateral allocation program to cause a computer to function as:
a collateral/loan information acquisition means acquiring collateral information and loan information about a credit customer being a processing object from a collateral/loan information storage means storing collateral information related to securities and loan information related to loans in a corresponding manner for each credit customer;
an objective function calculation means calculating an objective function related to linear programming with an amount of the collateral allocated for the loan as a variable, based on the collateral information and the loan information; and
a first replacing means replacing at least one or more variables of the variables of the objective functions with a sum of a first variable representing an amount of the collateral evenly allocated for the loans and a second variable representing, if there is a remaining amount of the collateral, an amount of the remaining amount individually allocated for the loans, and weighting the first variable.
